(19) United States
(12) Patent Application Publication
(10) Pub. No.: US 2026/0061926 A1
(43) Pub. Date: Mar. 5, 2026

(54) Three Kinds Integrated Self-Powered Motion Modules for Vehicle Box Slide-Out Systems

(71) Applicants: Xinfang Zhang, Shanxi (CN); Hengyuan Zhang, Shanxi (CN)

(72) Inventors: Xinfang Zhang, Shanxi (CN); Hengyuan Zhang, Shanxi (CN)

(21) Appl. No.: 18/822,467

(22) Filed: Sep. 3, 2024

(51) Int. Cl. B60P 3/34; B62D 63/04; F16H 19/04; F16H 57/02; F16H 57/029

(52) U.S. Cl. CPC B60P 3/34; B62D 63/04; F16H 19/04; F16H 57/029; F16H 2057/02034; F16H 2057/02082

(57) ABSTRACT

The present application relates to three kinds of self-powered integrated motion module and their use in a vehicle box slide-out system. Anyone of the self-powered integrated skew axis motion module, intersecting axis motion module or parallel axis motion module comprises a module box, a skew gear assembly or an intersecting gear assembly or a parallel gear assembly, a slider, a linear rack guide rail. The present application enables high-load and high-precision linear synchronous motion with self-contained driving power. A self-powered integrated vehicle box slide-out system includes the self-powered integrated skew axis motion module, or intersecting axis motion module or parallel axis motion module, a support frame, a load-bearing box, and a slide-out box. This application allows the slide-out box to extend and retract, thereby increasing interior space, while providing ease of installation and disassembly, and maintaining an aesthetically pleasing appearance.

### TECHNICAL FIELD

The present invention relates to three kinds of self-powered integrated motion modules and their use in a vehicle box slide-out system and belongs to the technical field of mechanical motion and vehicle expansion space.

### BACKGROUND OF THE INVENTION

The current existing mechanical transmission and motion modules require an external power source to function. The pattern—DE102019131278A1 discloses a rack and pinion driven transmission module that needs an external power source to operate, which occupies significant space and is inconvenient to install.

The pattern—US202117408020A discloses a vehicle slide-out device installed on both sides of the slide-out box. Due to the complexity of the mechanism, the telescopic drive device occupies a large space, is inconvenient to maintain, and increases the cost.

Considering the above-mentioned technical deficiencies, the inventors believe that current mechanical transmission and motion modules require an external power source and that, when used in vehicle slide-out systems, the slide-out mechanisms are relatively large, complicated to install, and occupy substantial space.

### SUMMARY OF THE INVENTION

To address the issues of complex installation and large space occupation of mechanical transmission and motion modules due to the external power source requirement, the present invention provides three kinds of integrated self-powered motion modules and their application in vehicle box slide-out systems. The three kinds of integrated self-powered motion modules include skew axis gears driven assembly, intersecting axis gears driven assembly and parallel axis gears driven assembly. These integrated self-powered motion modules come with their own power source, occupy a small volume, and are easy to install. When in use, simply connecting it to an electricity source allows the screw motion to be converted into the linear motion of the rack guide, achieving high-precision linear motion even under high loads.

### DETAILED DESCRIPTION OF THE PREFERRED EMBODIMENTS

To achieve the above objectives, the present invention adopts the following technical solutions:

Optionally, an integrated self-powered skew axis motion module includes a module box, a skew axis power box, a skew axis gearbox, a slider, and a rack guide rail. The module box is provided with a skew axis power box and a skew axis gearbox, the motor is set in the skew axis power box, and a skew gear assembly is set in the skew axis gearbox. The slider is positioned at the top of the interior of the module box, and the rack guide rail is set inside the slider. The slider and rack guide can involve types such as sliding friction, rolling friction, fluid friction, etc.

By adopting the above technical solutions, the skew axis power box and the skew axis gearbox are integrated within the module box, and with its own driving power source, connecting it to an electricity source allows the rack guide to perform heavy-load and high-precision linear motion on the slider. This achieves an integrated self-powered linear synchronous reciprocating linear motion, with easy installation and disassembly, and an aesthetically pleasing overall design.

The lower part of the slider is provided with an opening for the gear, connected with the skew axis gearbox.

By adopting the above technical solutions, the first end cover of the slider and second end cover of the slider ensure the normal operation of the slider. The slider ensures that the rack guide performs linear motion within the slider, with the rack guide meshing with the internal skew axis output gear of the skew axis gearbox through the slider bottom opening.

The skew axis power box and the skew axis gearbox are separated by a first partition, which is arranged perpendicularly to the length direction of the rack guide rail, with a first power hole set on the first partition. The skew axis power box contains a motor.

By adopting the above technical solutions, the motor is fixedly connected to the first partition, providing driving power to the skew axis gearbox through the first power hole on the first partition. The first partition separates the motor from the gear.

The bottom plate of the module box is provided with connecting holes.

By adopting the above technical solutions, the module box can be fixed through the bottom plate connecting holes.

The rack guide rail is provided with multiple first connection fixing holes along the length direction, and a second end connection fixing hole and a third end connection fixing hole are provided at both ends.

By adopting the above technical solution, it is used for fixing and connecting with the objects of the application scenario.

The top of the module box, above the rack guide rail, is provided with a top guard, which has fixing holes and does not interfere with the rack guide rail.

By adopting the above technical solutions, the module box can be fixed through the module box top plate fixing holes. Or the top guard can be removed, and the carried object can be directly connected and fixed on the rack guide rail. According to the different application scenario, if the carried object needs to be connected and fixed with the first connection fixing holes on the rack guide rail, the top guard can be selected to be disassembled without being used, and if the carried object needs to be connected and fixed with the second end connection fixing hole and the third end connection fixing hole of the rack guide rail, the top guard need not be disassembled.

One side of the module box, near the skew axis power box, is provided with a first motor heat radiation lid with a first cable routing hole.

By adopting the above technical solutions, the heat generated by the motor during operation can be dissipated through the first motor heat radiation lid. The first motor heat radiation lid facilitates maintenance and installation. The motor wires can pass through the first cable routing hole to supply power to the motor.

The skew axis gearbox is integrally provided with an output shaft, a worm, a worm gear, a skew axis output gear, a first snap spring, a second snap spring, a first bearing, a second bearing, a third bearing, and a fourth bearing. The skew axis output gear meshes with the rack guide rail through the slider bottom opening. Outside the skew axis gearbox is provided with a skew axis gearbox oil nozzle.

By adopting the above technical solutions, the motor, upon receiving power through the first cable routing hole, drives the worm to rotate. The worm then drives the worm gear, performing speed change and reduction. The worm gear synchronously drives the skew axis output gear to rotate. The skew axis output gear engages with the rack guide rail through the gear opening in the slider base plate, causing the rack guide rail to move reciprocally, thus transforming the rotary motion into linear motion of the rack guide rail. The first and second bearings support the output shaft, reducing friction during its motion. The third and fourth bearings support the worm, reducing friction during its motion. The skew axis gearbox oil nozzle provides lubrication to the gears.

The outside of the module box is provided with a first seal ring, a second seal ring, a third seal ring, a first bearing cover, a second bearing cover, and a third bearing cover. The first seal ring, the first bearing cover, and the first bearing are arranged together. The second seal ring, the second bearing cover, and the second bearing are arranged together. The third seal ring, the third bearing cover, and the third bearing are arranged together. The fourth seal ring is set on the first power hole, arranged with the fourth bearing.

By adopting the above technical solutions, the first seal ring, the first bearing cover, and the first bearing support the output shaft in cooperation with the corresponding second seal ring, the second bearing cover, and the second bearing, facilitating the installation and maintenance of the output shaft, worm gear, and skew axis output gear. The third seal ring, the third bearing cover, and the third bearing support the worm, facilitating its installation and maintenance. The fourth seal ring and the fourth bearing support the motor and worm, facilitating the installation of the motor.

Optionally, a self-powered integrated intersecting axis motion module, compared to a self-powered integrated skew axis motion module, the structure is different only with the skew axis gearbox and the skew axis power box, but the functions and motion principles are the same. This second intersecting axis motion module can replace the first skew axis motion module. A self-powered integrated intersecting axis motion module includes a module box, an intersecting gear assembly, an intersecting axis power box, an intersecting axis gear box, a slider, a rack guide rail, a second partition, a second power hole, an intersecting axis gear box cover, a second motor heat radiation lid, a second cable routing hole, an input bevel gear, first and second intersecting output shaft, an output bevel gear, a second intersecting axis gear, a third intersecting axis gear, a fourth intersecting axis gear, six intersecting axis bearings, a first intersecting axis seal ring, a second intersecting axis seal ring, three snap springs, and an intersecting axis gearbox oil nozzle.

By adopting a self-powered integrated intersecting axis motion module, the technical solution differs only in the internal structure of the intersecting axis gearbox and the intersecting axis power box, but the functions and movement principles remain the same, achieving the same motion functionality. The second partition is L-shaped and separates the intersecting axis power box from the intersecting axis gearbox. The motor receives power through the second cable routing hole, driving the input bevel gear inside the intersecting axis gear box to rotate and turn by 90 degrees and decelerate. The input bevel gear engages with the output bevel gear. The motor in the intersecting axis gear box drives the input bevel gear to rotate, which then drives the output bevel gear. The output bevel gear and the second intersecting axis gear are fixed on the second output shaft. Output bevel gear and second intersecting axis gear rotate synchronously, the second intersecting axis gear drives the third intersecting axis gear, and the third and fourth intersecting axis gears are fixed above the first intersecting output shaft. The third and fourth intersecting axis gears rotate and decelerate synchronously. The fourth intersecting axis gear engages the rack guide through the gearbox bottom opening of the slider, The fourth intersecting axis gear drives the rack guide in reciprocating motion. With the same slip-out and take-back action, the fourth intersecting axis gear transforms the spiral motion into a straight-line motion of the rack rail.

Optionally, a self-powered integrated parallel axis motion module, compared to a self-powered integrated intersecting axis motion module, the structure is different only with the intersecting axis gearbox and the intersecting axis power box, but the functions and motion principles are the same. The parallel axis motion module can replace the intersecting axis motion module.

The self-powered integrated parallel axis motion module includes a module box, a parallel gear assembly, a parallel axis power box, a parallel axis gearbox, a motor, a slider, and a rack guide rail, a third partition, a third motor heat radiation lid, a third cable routing hole, a third power hole, a parallel axis motor gear, a first parallel output shaft, a second parallel output shaft, a first parallel axis gear, a second parallel axis gear, a third parallel axis gear, a fourth parallel axis gear, a parallel axis gearbox cover, a parallel axis gearbox oil nozzle, a first parallel axis bearing, a second parallel axis bearing, a third parallel axis bearing, a fourth parallel axis bearing, a first parallel axis seal ring, a second parallel axis seal ring, a first parallel axis snap spring, a second parallel axis snap spring, a third parallel axis snap spring, and a fourth parallel axis snap spring.

By adopting a self-powered integrated parallel axis motion module, the technical solution differs only in the internal structure of the parallel axis gearbox and the parallel axis power box, but the functions and movement principles remain the same, achieving the same motion functionality. The third partition is L-shaped and separates the parallel axis power box from the parallel axis gearbox. The parallel axis power box contains a motor. The third motor heat radiation lid corresponds to the second parallel axis seal ring, facilitating motor installation and heat dissipation. The parallel axis gear box cover corresponds to the first parallel axis seal ring. The first and third parallel axis bearings are set on one side inside the gear box, while the second and fourth parallel axis bearings are set on the parallel axis gear box cover. The first output shaft supports the first and second parallel axis gears, while the second output shaft supports the third and fourth parallel axis gears, facilitating the installation and maintenance of the parallel gear box cover. The first, second, third, and fourth parallel axis gears are arranged parallel to the length direction of the rack guide. The motor gear meshes with the first parallel axis gear, driving it to rotate. The second parallel axis gear meshes with the third parallel axis gear, and the fourth parallel axis gear meshes with the rack guide through the slider bottom opening. The second parallel axis gear drives the third parallel axis gear and the fourth axis gear to rotate and decelerate, and the fourth parallel gear drives the rack guide rail to do reciprocating motion, and realizes the sliding out and retracting action, and the fourth parallel axis gear transforms the helical motion into the linear motion of the rack guide rail.

Optionally, an integrated self-powered vehicle box slide-out system includes a self-powered integrated skew axis motion module, or the intersecting axis motion module or the parallel axis motion module, a support frame, a load-bearing box, and a slide-out box, wherein the self-powered integrated motion module of the skew axis motion module, or the intersecting axis motion module or the parallel axis motion module is disposed inside the load-bearing box, the bottom of the module box is connected to the support frame, the linear rack guide rail is fixedly connected with the top of the load-bearing box. The load-bearing boxes are arranged in parallel on both corresponding sides below the slide-out box.

By adopting the above technical solutions, the rack guide rail of the self-powered integrated skew axis motion module, or the intersecting axis motion module or the parallel axis motion module, is fixedly connected to the top inside the load-bearing box, driving the load-bearing box to slide, thereby driving the slide-out box to extend and retract. The rack guide rail bears the weight of the load-bearing box, achieving high-precision linear motion under high loads. The self-powered integrated skew axis motion module, or the intersecting axis motion module or the parallel axis motion module, is integrated within the load-bearing box, occupying little space, increasing the usable area inside the vehicle, and facilitating installation and disassembly. The load-bearing box isolates the self-powered integrated skew axis motion module, or the intersecting axis motion module or the parallel axis motion module from external contact, facilitating sealing and extending its service life.

The length direction of the load-bearing box is provided with a long strip opening, and one side is equipped with a control module.

By adopting the above technical solutions, the rack guide bears the weight of the load-bearing box, which bears the entire weight of the slide-out box. The long strip opening allows for the slide-out and retraction actions, and the control module on one side controls the length and position of the slide-out box's retraction.

The support frame includes a top plate, a vertical plate, and a bottom plate.

By adopting the above technical solutions, the top plate of the support frame supports the self-powered integrated skew axis motion module, or the intersecting axis motion module or the parallel axis motion module. The long strip opening of the load-bearing box slides out beside the vertical plate of the support frame. The bottom plate supports the entire slide-out box, without needing to disassemble the vehicle chassis. The bottom plate of the support frame is directly fixed to the vehicle body, allowing the entire slide-out box to be suspended at the vehicle opening. The support frame transfers the weight of the slide-out box to the vehicle body. When the vehicle is stationary, the slide-out box fully extends from the opening in the vehicle body, increasing the interior space. After retraction, the slide-out box is flush with the vehicle's exterior, maintaining the overall aesthetic appearance.

The present application includes at least one of the following advantageous technical effects:
1. The self-powered integrated skew axis motion module, or the intersecting axis motion module or the parallel axis motion module, with the power box and gear box integrated within the module box, do not require external motor for driving; upon connecting electricity to the module, the motor inside can drive the internal gears in the gear box to perform linear reciprocating motion. It occupies minimal space and is easy to install and disassemble.
2. The self-powered integrated skew axis motion module, or the intersecting axis motion module or the parallel axis motion module, with the linear rack guide rail set within the slider to reduce motion friction, are used to support, and guide the moving parts, enabling reciprocating linear motion in a specified direction.
3. The self-powered integrated skew axis motion module, or the intersecting axis motion module or the parallel axis motion module, is allowed to bear a certain torque and achieve high-precision linear motion under high loads.
4. An integrated self-powered vehicle box slide-out system, where the load-bearing box can isolate the three kinds integrated self-powered motion modules from external influences. It is neat and aesthetically pleasing and can increase the usable space within the vehicle.
5. An integrated self-powered vehicle box slide-out system that does not require the disassembly of the vehicle's lower chassis. It is easy to install and disassemble; by simply fixing the bottom plate of the support frame to the vehicle, the entire slide-out box can be set at the vehicle's opening.

### BRIEF DESCRIPTION OF DRAWINGS

To explain the technical solutions of the present invention more clearly, the following figures are provided. These figures illustrate some embodiments of the present invention and are not exhaustive. Those skilled in the art can derive other figures from these without any inventive effort.

FIG. 1: 1A is a top oblique view of the integrated self-powered skew axis motion module in the specific embodiment of the present invention. 1B is a bottom oblique view of the integrated self-powered skew axis motion module in the specific embodiment of the present invention.

FIG. 2 is a structure diagram of the integrated self-powered skew axis motion module in the specific embodiment of the present invention.

FIG. 3: 3A is a top oblique view of the slider of the integrated self-powered skew axis motion module in the specific embodiment of the present invention. 3B is a bottom oblique view of the slider of the integrated self-powered skew axis motion module in the specific embodiment of the present invention.

FIG. 4 is an oblique view of the linear rack guide rail in the specific embodiment of the present invention.

FIG. 5: 5A is an upper-sectional view of the integrated self-powered skew axis motion module box in the specific embodiment of the present invention. 5B is a lower-sectional view of the integrated self-powered skew axis motion module box in the specific embodiment of the present invention. 5C is a schematic diagram of the internal structure of the integrated self-powered skew axis motion module box in the specific embodiment of the present invention.

FIG. 6 is a sectional view of the power box and gearbox inside the skew axis motion module box in the specific embodiment of the present invention.

FIG. 7 is an explosive view of the integrated self-powered skew axis driven motion module in the specific embodiment of the present invention.

FIG. 8: 8A is a schematic view of the integrated self-powered skew axis motion module (without the top guard) in the non-extended state in the specific embodiment of the present invention. 8B is a schematic view of the integrated self-powered skew axis motion module (without the top guard) in the intermediate extended state in the specific embodiment of the present invention. 8C is a schematic view of the integrated self-powered skew axis motion module (without the top guard) in the fully extended state in the specific embodiment of the present invention.

FIG. 9: 9A is a schematic view of the integrated self-powered skew axis motion module (without the top guard) in the non-retracted state in the specific embodiment of the present invention. 9B is a schematic view of the integrated self-powered skew axis motion module (without the top guard) in the intermediate retracted state in the specific embodiment of the present invention. 9C is a schematic view of the integrated self-powered skew axis motion module (without the top guard) in the fully retracted state in the specific embodiment of the present invention.

FIG. 10A is the top and bottom oblique views of the integrated self-powered intersecting axis motion module in the specific embodiment of the present invention.

FIG. 10B is a structural schematic view of the integrated self-powered intersecting axis motion module in the specific embodiment of the present invention.

FIG. 10C is a sectional view of the power box and gearbox inside the intersecting axis motion module box in the specific embodiment of the present invention.

FIG. 10D is an explosive view of integrated self-powered intersecting axis motion module in the specific embodiment of the present invention.

FIG. 11A is the top and bottom oblique views of the integrated self-powered parallel axis motion module in the specific embodiment of the present invention.

FIG. 11B is a structural schematic view of the integrated self-powered parallel axis motion module in the specific embodiment of the present invention.

FIG. 11C is a sectional view of the power box and gearbox inside the parallel axis motion module box in the specific embodiment of the present invention.

FIG. 11D is an explosive view of integrated self-powered parallel axis motion module in the specific embodiment of the present invention.

FIG. 12 is an internal structural schematic view of the load-bearing box in the specific embodiment of the present invention.

FIG. 13 is a structural schematic view of the support frame in the specific embodiment of the present invention.

FIG. 14: 14A is a top oblique view of the integrated self-powered skew axis motion module (without the top guard) in the specific embodiment of the present invention. 14B is a bottom oblique view of the integrated self-powered skew axis motion module (without the top guard) in the specific embodiment of the present invention.

FIG. 15: 15A is a front view of the internal structure of the load-bearing box in the vehicle box slide-out system driven by the integrated self-powered skew axis motion module in the specific embodiment of the present invention. 15B is a rear view of the internal structure of the load-bearing box in the vehicle box slide-out system driven by the integrated self-powered skew axis motion module in the specific embodiment of the present invention.

FIG. 16 is a front view of the slide-out box in the specific embodiment of the present invention.

FIG. 17 is a schematic view of the vehicle body when the slide-out box is fully extended in the specific embodiment of the present invention.

FIG. 18 is a schematic view of the vehicle body when the slide-out box is fully retracted in the specific embodiment of the present invention.

FIG. 19: 19A is a schematic view of the slide-out system driven by the skew axis motion module or the intersecting axis motion module or the parallel axis motion module in the non-extended state in the specific embodiment of the present invention. 19B is a schematic view of the slide-out system driven by the skew axis motion module or the intersecting axis motion module or the parallel axis motion module in the fully extended state in the specific embodiment of the present invention. FIG. 19C is an oblique view of the slide-out box with the skew axis motion module or the intersecting axis motion module or the parallel axis motion module fully extended in the specific embodiment of the present invention. 19D is a side view of the slide-out box with the skew axis motion module or the intersecting axis motion module or the parallel axis motion module fully extended in the specific embodiment of the present invention.

FIG. 20: 20A is a schematic view of the slide-out system driven by the skew axis motion module or the intersecting axis motion module or the parallel axis motion module fully extended in the specific embodiment of the present invention. 20B is a schematic view of the slide-out system driven by the skew axis motion module or the intersecting axis motion module or the parallel axis motion module fully retracted in the specific embodiment of the present invention. 20C is an oblique view of the slide-out box with the skew axis motion module or the intersecting axis motion module or the parallel axis motion module fully retracted in the specific embodiment of the present invention. 20D is a side view of the slide-out box with the skew axis motion module or the intersecting axis motion module or the parallel axis motion module fully retracted in the specific embodiment of the present invention.

### BRIEF DESCRIPTION OF THE FIGS.

Follow are the reference numbers appear in the drawings:

1. Module box, 101. Top guard
2. Slider
3. Linear rack guide rails, 301. First connection fixing hole, 302. Second end connection fixing hole, 303 Third end connection fixing hole
4A. First partition, 4B. Second partition, 4C. Third partition
5. Motor
6. Output shaft, 601A. First snap spring, 601B. Second snap spring
7A. First motor heat radiation lid, 7B. Second motor heat radiation lid, 7C. Third motor heat radiation lid, 701. First cable routing hole, 702. Second cable routing hole, 703. Third cable routing hole
8. Worm
9. Worm gear
10. Skew axis output gear
11A. First end cover of the slider, 11B. Second end cover of the slider
12A. First bearing cap, 12B. Second bearing cap, 12C. Third bearing cover
13A. First seal ring, 13B. Second seal ring, 13C. Third seal ring, 13D. Fourth seal ring
14A. First bearing, 14B. Second bearing; 14C. Third bearing, 14D. Fourth bearing
15. Slider oil nozzle
16A. Skew axis gearbox oil nozzle, 16B. Intersecting axis gearbox oil nozzle, 16C. Parallel axis gearbox oil nozzle
17A. Skew axis power box, 17B. Intersecting axis power box, 17C. Parallel axis power box.
18A. Skew axis gear box, 18B. Intersecting axis gear box, 18C. Parallel axis gear box.
19A. First power hole, 19B. Second power hole, 19C. Third power hole
20. Slider bottom opening
21A. Module box bottom plate connecting hole, 21B. Module box top plate fixing hole
22. Control component
23. Skew axis motion modules
24. Intersecting axis motion module, 240. Input bevel gear, 243A. First intersecting output shaft, 243B. Second intersecting output shaft, 244A. Output bevel gear, 244B. Second intersecting axis gear, 244C. Third intersecting axis gear, 244D. Fourth intersecting axis gear, 245. Intersecting axis gear box cover, 247A First intersecting axis bearing, 247B Second intersecting axis bearing, 247C. Third intersecting axis bearing, 247D. Fourth intersecting axis bearing, 247E. Fifth intersecting axis bearing, 247F. Sixth intersecting axis bearing, 248A. First intersecting axis seal ring, 248B. Second intersecting axis seal ring, 249A. First intersecting axis snap spring, 249B. Second intersecting axis snap spring, 249C. Third intersecting axis snap spring
25. Parallel axis motion module, 250. Parallel axis motor gear, 253A. First parallel output shaft, 253B. Second parallel output shaft, 254A. First parallel axis gear, 254B. Second parallel axis gear, 254C. Third parallel axis gear, 254D. Fourth parallel axis gear, 255. Parallel axis gear box cover, 257A. First parallel axis bearing, 257B. Second parallel axis bearing, 257C. Third parallel axis bearing, 257D. Fourth parallel axis bearing, 258A. First parallel axis seal ring, 258B. Second parallel axis seal ring, 259A. First parallel axis snap spring, 259B. Second parallel axis snap spring, 259C. Third parallel axis snap spring, 259D. Fourth parallel axis snap spring
26. Support frame, 261. Top plate, 262. Bottom plate, 263. Vertical plate
27. Load-bearing boxes, 271. First sealing plate, 272. Second sealing plate, 273. Fixing hole
28. Long opening
29. Slide-out boxes
30. Vehicle body
31. Skew gear assembly
32. intersecting axis gear assembly
33. Parallel gear assembly

### DETAILED DESCRIPTION OF THE INVENTION

To make the objectives, features, and advantages of the present invention clearer and more understandable, the technical solutions of the present invention will be described in detail below in conjunction with the attached drawings of specific embodiments. It is evident that the described embodiments are only some examples of the present invention and not all its examples. Based on the embodiments of this patent, those skilled in the art can obtain other embodiments without making inventive efforts, which fall within the scope of protection of this patent.

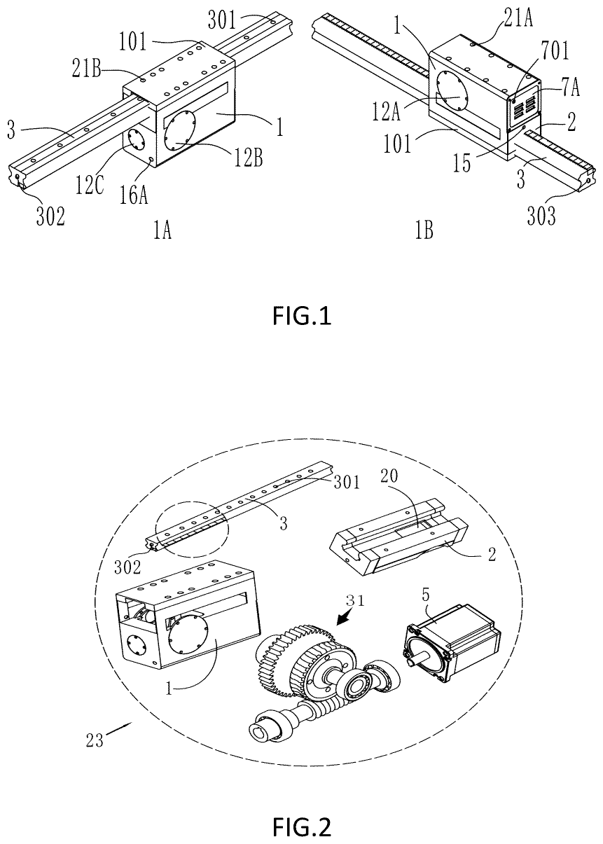

Embodiment 1: As shown in FIG. 1, FIG. 2, a self-powered integrated skew axis motion module includes a module box 1, a top guard 101, a skew gear assembly 31, a motor 5, a slider 2, and a linear rack guide rail 3. The skew gear assembly 31 and the motor 5 is set inside the module box 1, the slider 2 is set at the top part inside the module box 1 and is equipped with a slider bottom opening 20. The linear rack guide rail 3 is placed inside the slider 2 and is provided with first connection fixing holes 301, a second end connection fixing hole 302 and a third end connection fixing hole 303. The side of the module box 1 is equipped with a first motor heat radiation lid 7A with a first cable routing hole 701. Another side of the module box 1 is equipped with third bearing cap 12C and skew axis gearbox oil nozzle 16A. The module box 1 is correspondingly provided with a first bearing cap 12A and a second bearing cap 12B along the length direction ; the bottom plate of the module box 1 is provided with module box bottom plate connection holes 21A, and the top guard 101 is provided with module box top plate fixing holes 21B.

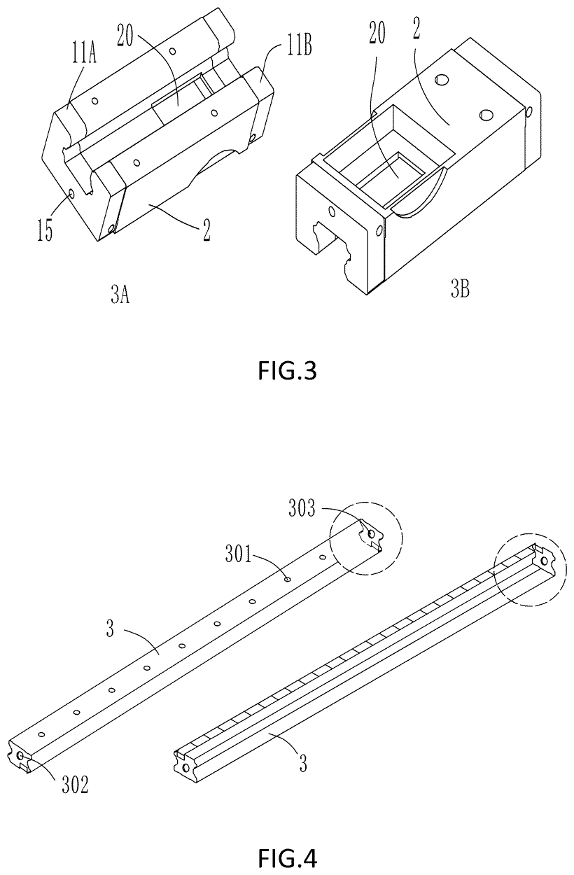

According to FIG. 3, the slider 2 is equipped with a first end cover 11A and a second end cover 11B at both ends to protect the slider 2 and the linear rack guide rail 3. The first end cover 11A is equipped with a slider oil nozzle 15, and the slider oil nozzle 15 provides lubrication to the slider 2. The lower part of the slider 2 is provided with a slider bottom opening 20.

As shown in FIG. 4, the linear rack guide rail 3 is provided with first connection fixing holes 301, a second end connection fixing hole 302 and a third end connection fixing hole 303, used for fixed connections to objects in the application scenario.

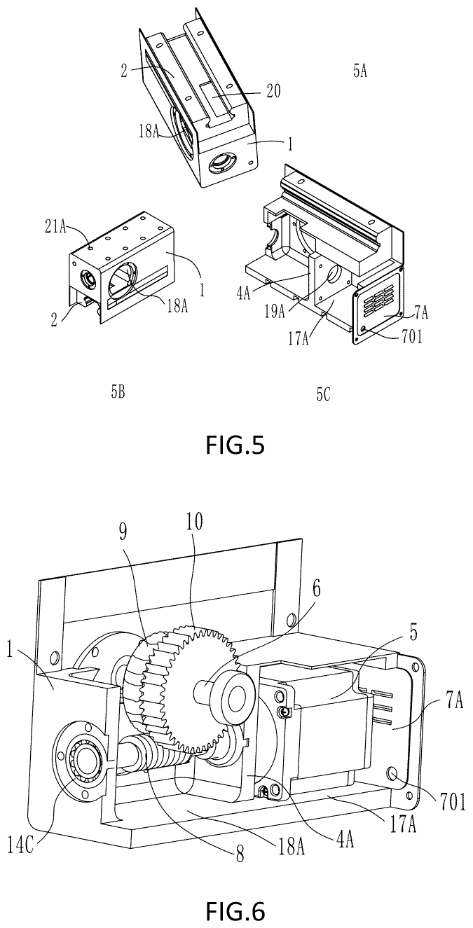

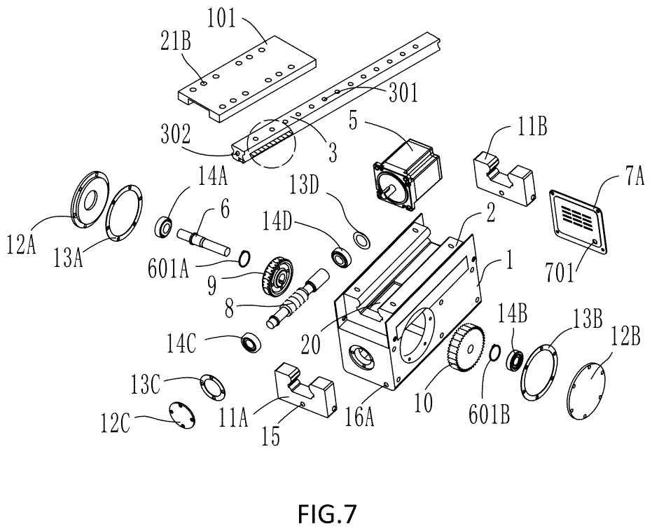

As shown in FIGS. 5-7, the module box 1 is equipped with a first partition 4A, a skew axis power box 17A and a skew axis gearbox 18A. The skew axis power box 17A and the skew axis gearbox 18A are separated by first partition 4A. The first partition 4A is equipped with a first power hole 19A, and the skew axis power box 17A is equipped with a motor 5. The gearbox 18A is integrally provided with an output shaft 6, a worm 8, a worm gear 9, a skew axis output gear 10, a first snap spring 601A, a second snap spring 601B, a first bearing 14A, a second bearing 14B, a third bearing 14C, and a fourth bearing 14D. The motor 5 is connected with worm 8 through first power hole 19A, and the third bearing 14C and fourth bearing 14D are set at both ends of worm 8. The output shaft 6 is fixed with a worm gear 9 and a skew axis output gear 10. The two ends are provided with a first bearing 14A and a second bearing 14B. The first snap spring 601A and the second snap spring 601B are fixed to the skew axis output gear 10, and the output gear 10 is meshed with the linear rack guide rail 3 through the slider bottom opening 20.

Outside the module box 1, a first seal ring 13A, a second seal ring 13B, a third seal ring 13C, a first bearing cap 12A, a second bearing cap 12B and a third bearing cap 12C are set. The first seal ring 13A, the first bearing cap 12A and the first bearing 14A are set together. The second seal ring 13B, the second bearing cap 12B and the second bearing 14B are set together. The third seal ring 13C, the third bearing cap 12C and the third bearing 14C are set together. The fourth seal ring 13D is set on the first power hole 19A and is set with the fourth bearing 14D. The outer side of the module box 1 near the skew axis gearbox 18A is equipped with the skew axis gearbox oil nozzle 16A, which is used to lubricate the internal components of the skew axis gearbox 18A.

Motor 5 drives worm gear 9 through worm 8, worm gear 9 drives output shaft 6 to rotate, synchronously drives skew axis output gear 10 to rotate, skew axis output gear 10 drives linear rack guide rail 3 to do reciprocating motion, and skew axis output gear 10 transforms spiral motion into linear motion of linear rack guide rail 3.

The module box 1 is provided with module box bottom plate connecting holes 21A and module box top plate fixing holes 21B for fixing the module box 1 to the object in the application scenario. According to the different application scenario, if the carried object needs to be connected and fixed with the first connection fixing holes 301 on the linear rack guide rail 3, the top guard 101 can be selected to be disassembled without being used, and if the application carried object needs to be connected and fixed with the second end connection fixing hole 302 and the third end connection fixing hole 303 of the linear rack guide rail 3, the top guard 101 need not be disassembled.

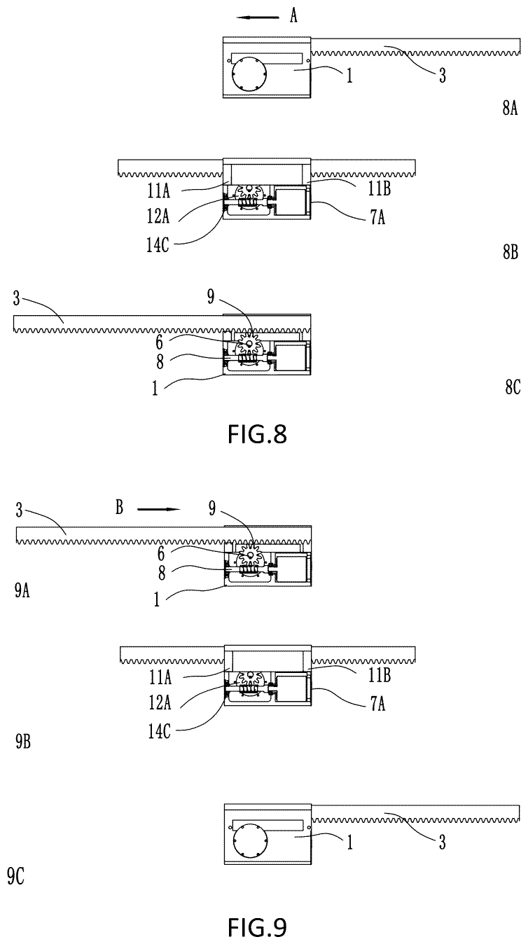

Refer to FIG. 8, provide power to motor 5, motor 5 drives worm 8, worm 8 drives worm gear 9, synchronous drive skew axis output gear 10 rotation, The skew axis output gear 10 engages the linear rack guide rail 3 through the slider bottom opening 20, and the skew axis output gear 10 drives the linear rack guide rail 3 to make the slide out motion. Skew axis output gear 10 converts the spiral motion to the linear motion of linear rack guide rail 3, to realize a self-powered integrated skew axis motion module sliding out. In FIGS. 8, 8A is the stationary state, 8B is the intermediate state of sliding out, and 8C is the state of completely sliding out, and the direction of sliding out is shown by arrow A.

Refer to FIG. 9: provide power to motor 5, motor 5 reverse drives worm 8, worm 8 drives worm 9, synchronous drives skew axis output gear 10 rotation, The skew axis output gear 10 engages the linear rack guide rail 3 through the slider bottom opening 20. Skew axis output gear 10 drives linear rack guide rail 3 to do recovery movement, skew axis output gear 10 converts the spiral motion to the linear motion of linear rack guide rail 3, to realize a self-powered integrated skew axis motion module retracting. In FIG. 9, 9A is the state of sliding out, 9B is the intermediate state of retraction, and 9C is the state of complete retraction, and the direction of retraction is shown by arrow B.

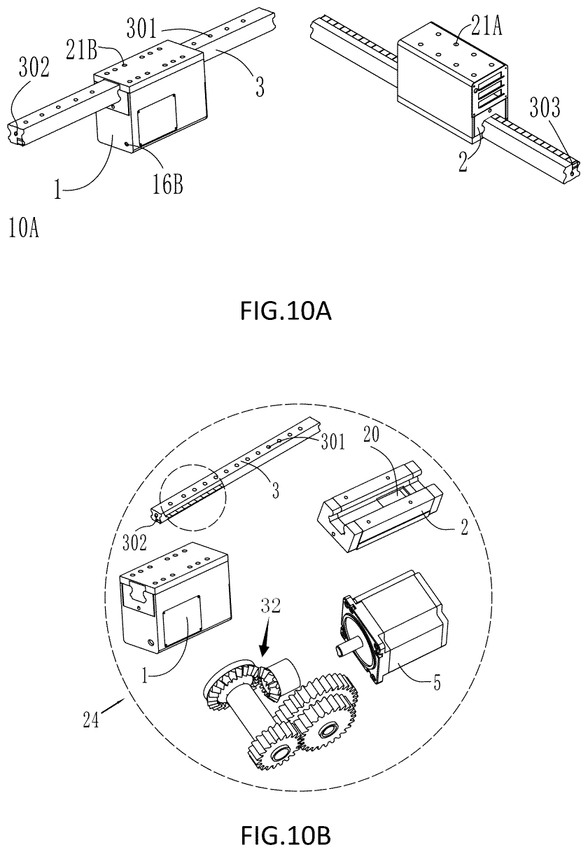

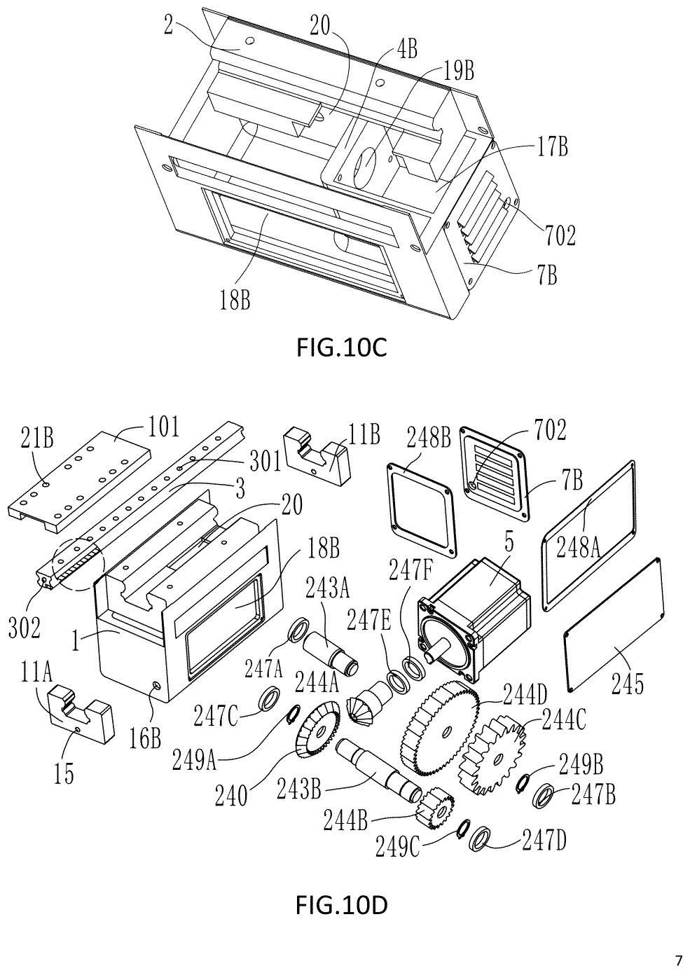

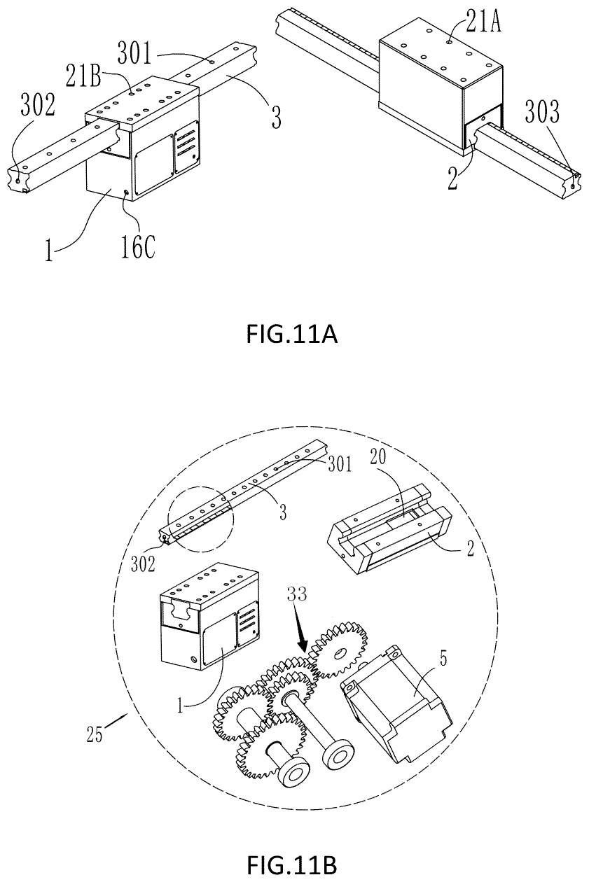

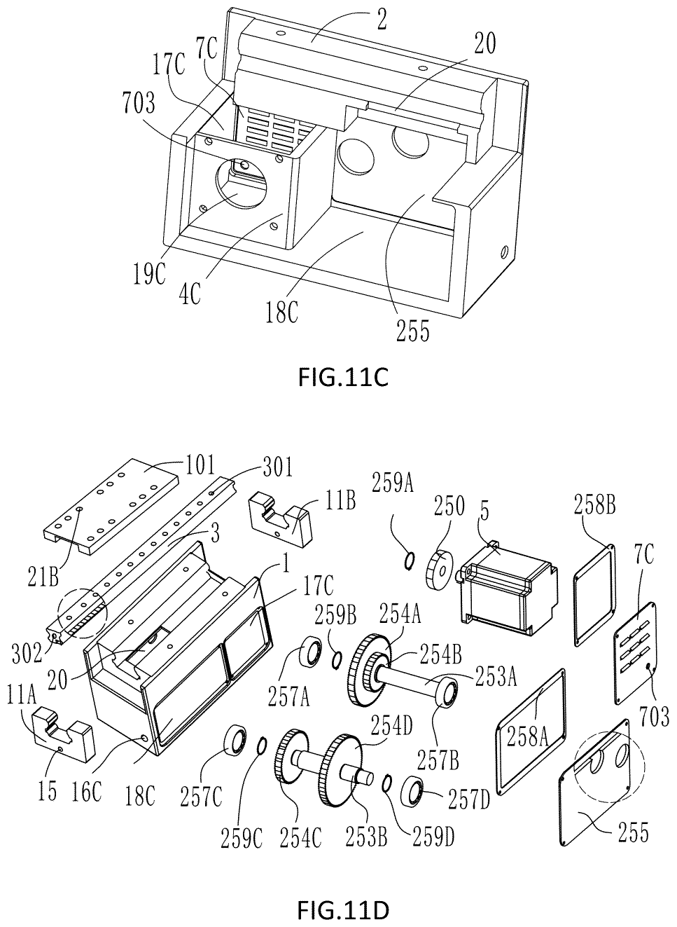

Embodiment 2: Referring to FIGS. 10A, 10B, 10C, 10D: a self-powered integrated intersecting axis motion module, compared to a self-powered integrated skew axis motion module in Embodiment 1, this embodiment uses an intersecting axis motion module 24 to be capable of replacing the skew axis motion module 23 in Embodiment 1. The structure is different only with the skew axis gearbox 18A and the skew axis power box 17A, but the function and motion principle are the same.

A self-powered integrated intersecting axis motion module 24 includes a module box, an intersecting gear assembly 32, an intersecting axis power box 17B, an intersecting axis gearbox 18B, a motor 5, a slider 2, and a linear rack guide rail 3, a second partition 4B, a second motor heat radiation lid 7B, a second cable routing hole 702, a second power hole 19B, an input bevel gear 240, a first intersecting output shaft 243A, a second intersecting output shaft 243B, an output bevel gear 244A, a second intersecting axis gear 244B, a third intersecting axis gear 244C, a fourth intersecting axis gear 244D, an intersecting axis gearbox cover 245, an intersecting axis gearbox oil nozzle 16B, a first intersecting axis bearing 247A, a second intersecting axis bearing 247B, a third intersecting axis bearing 247C, a fourth intersecting axis bearing 247D, a fifth intersecting axis bearing 247E, and a sixth intersecting axis bearing 247F, a first intersecting axis seal ring 248A, a second intersecting axis seal ring 248B, a first intersecting axis snap spring 249A, a second intersecting axis snap spring 249B, and a third intersecting axis snap spring 249C.

The second partition 4B is set in L-shape, the second partition 4B is provided with a second power hole 19B, the intersecting axis power box 17B and the intersecting axis gear box 18B are separated by the second partition 4B. The intersecting axis power box 17B is provided with the motor 5, the slider 2 is set at the top of the module box 1, and the linear rack guide rail 3 is set inside the slider 2. The intersecting axis power box 17B is provided with the motor 5, the second motor heat radiation lid 7B is provided with a second cable routing hole 702, the second motor heat radiation lid 7B is provided in correspondence with the second intersecting axis seal ring 248B, the output shaft of the motor is provided with a first intersecting axis bearing 247A and a second intersecting axis bearing 247B, and the motor is connected to the input bevel gear 240 through the second power hole 19B. The intersecting axis gear box 18B is provided intersecting axis gear assembly 32, intersecting axis gear box cover 245 is provided in correspondence with first intersecting axis seal ring 248A, the first intersecting output shaft 243A is provided with third intersecting axis gear 244C, fourth intersecting axis gear 244D, first intersecting axis bearing 247A, second intersecting axis bearing 247B, second intersecting axis snap spring 249B, second intersecting output shaft 243B is provided with output bevel gear 244A, second intersecting axis gear 244B, third intersecting axis bearing 247C, fourth intersecting axis bearing 247D, first intersecting axis snap spring 249A, and third intersecting axis snap spring 249C, the input bevel gear 240 engages with the output bevel gear 244A, and the output bevel gear 244A drives the second intersecting axis gear 244B. Through the first intersecting output shaft 243A and the third intersecting axis gear 244C the fourth intersecting axis gear 244D is driven to rotate. the fourth intersecting axis gear 244D meshes with the linear rack guide rail 3 through the slider bottom opening 20, and the intersecting axis gearbox 18B is provided with an intersecting axis gearbox oil nozzle 16B on the outer side of the intersecting axis gearbox 18B for providing lubrication to the intersecting gear assembly inside the intersecting axis gearbox 18B.

The electric wire passes through the second cable routing hole 702 on the second motor heat radiation lid 7B of the intersecting axis power box 17B, to provide power to the motor 5, and the motor 5 passes through the second power hole 19B to drive the input bevel gear 240 of the intersecting axis gear assembly 32 inside the intersecting axis gear box 18B, and the input bevel gear 240 drives the output bevel gear 244A to rotate, and the output bevel gear 244A and the second intersecting axis gear 244B are fixed on the second intersecting output shaft 243B, and the output bevel gear 244A is fixed on the second intersecting output shaft 243B. The output bevel gear 244A and the second intersecting axis gear 244B rotate synchronously, the second intersecting axis gear 244B drives the third intersecting axis gear 244C to rotate, the third intersecting axis gear 244C and the fourth intersecting axis gear 244D are fixed on the first intersecting output shaft 243A, the third intersecting axis gear 244C and the fourth intersecting axis gear 244D rotate synchronously, and the fourth intersecting axis gear 244D meshes with the linear rack guide rail 3 through the slider bottom opening 20, the fourth intersecting axis gear 244D drives the linear rack guide rail 3 in reciprocating motion to realize the sliding out and retracting action, and the fourth intersecting axis gear 244D transforms the helical motion into a linear motion of the linear rack guide rail 3.

Embodiment 3: Refer to 11A, 11B, 11C, 11D: a self-powered integrated parallel axis motion module, compared to a self-powered integrated intersecting axis motion module in Embodiment 2, this embodiment uses a parallel axis motion module 25 to be capable of replacing the intersecting axis motion module 24 in Embodiment 2. The structure is different only with the intersecting axis gearbox 18B and the intersecting axis power box 17B, but the function and motion principle are the same.

The parallel axis motion module 25 includes a module box 1, a parallel gear assembly 33, a parallel axis power box 17C, a parallel axis gearbox 18C, a motor 5, a slider 2, and a linear rack guide rail 3, a third partition 4C, a third motor heat radiation lid 7C, a third cable routing hole 703, a third power hole 19C, a parallel axis motor gear 250, a first parallel output shaft 253A, a second parallel output shaft 253B, a first parallel axis gear 254A, a second parallel axis gear 254B, a third parallel axis gear 254C, a fourth parallel axis gear 254D, a parallel axis gearbox cover 255, a parallel axis gearbox oil nozzle 16C, a first parallel axis bearing 257A, a second parallel axis bearing 257B, a third parallel axis bearing 257C, a fourth parallel axis bearing 257D, a first parallel axis seal ring 258A, a second parallel axis seal ring 258B, a first parallel axis snap spring 259A, a second parallel axis snap spring 259B, a third parallel axis snap spring 259C, and a fourth parallel axis snap spring 259D.

The third partition 4C is L-shaped, the parallel axis power box 17C and the parallel axis gear box 18C are separated by the third partition 4C, the third partition 4C is provided with a third power hole 19C, the parallel power box 17C is provided with a motor 5 inside, the motor 5 is secured to the third partition 4C, and the motor 5 extends the output parallel axis motor gear 250 to the parallel axis gear box 18C through the third power hole 19C on the third partition 4C. Inside the gear box 18C, the output shaft of the motor is provided with a parallel axis motor gear 250 and a first parallel axis snap spring 259A, the first parallel axis snap spring 259A catches the motor gear 250, the third motor heat radiation lid 7C and the second parallel axis seal ring 258B are provided correspondingly, and the third motor heat radiation lid 7C is provided with a third cable routing hole 703. the parallel axis gear box 18C is provided with a parallel gear assembly 33, and a parallel axis gearbox cover 255 and first parallel axis seal ring 258A are provided correspondingly, first parallel output shaft 253A is provided with first parallel axis bearing 257A, second parallel axis bearing 257B, first parallel axis gear 254A, second parallel axis gear 254B and second parallel snap spring 259B, second parallel snap spring 259B snaps to fix first parallel axis gear 254A, first parallel axis snap spring 259A snap-fastening the parallel motor gear 250, the parallel motor gear 250 engaging the first parallel axis gear 254A. Two ends of the second parallel output shaft 253B is respectively fixed to the inner side of the parallel axis gear box 18C and the parallel axis gear box cover 255 by means of the third parallel axis bearing 257C and the fourth parallel axis bearing 257D. And the second parallel output shaft 253B is fixed with the third parallel axis gear 254C and the fourth parallel axis gear 254D at the same time, and the second parallel output shaft 253B is provided with the third parallel axis snap spring 259C and a fourth parallel axis snap spring 259D fixedly clamping the third parallel gear 254C and the fourth parallel gear 254D. The second parallel axis gear 254B meshing with the third parallel axis gear 254C, the fourth parallel axis gear 254D meshing with the linear rack guide rail 3 through the slider bottom opening 20. The parallel axis gear box 18C is provided with a parallel axis gearbox oil nozzle 16C at the outer side to provide lubrication to the parallel gear assembly inside the parallel axis gearbox 18C.

The electric wire passes through the third cable routing hole 703 to provide power to the motor 5 to drive the parallel axis motor gear 250, the parallel axis motor gear 250 drives the first parallel axis gear 254A and the second parallel axis gear 254B of the parallel gear assembly 33 to rotate at the same time, the second parallel axis gear 254B drives the third parallel axis gear 254C and the fourth parallel axis gear 254D to rotate, and the fourth parallel axis gear 254D drives the linear rack guide rail 3 to do reciprocating motion, realizing the sliding out and retracting action, and the fourth parallel axis gear 254D transforms the helical motion into the linear motion of the linear rack guide rail 3.

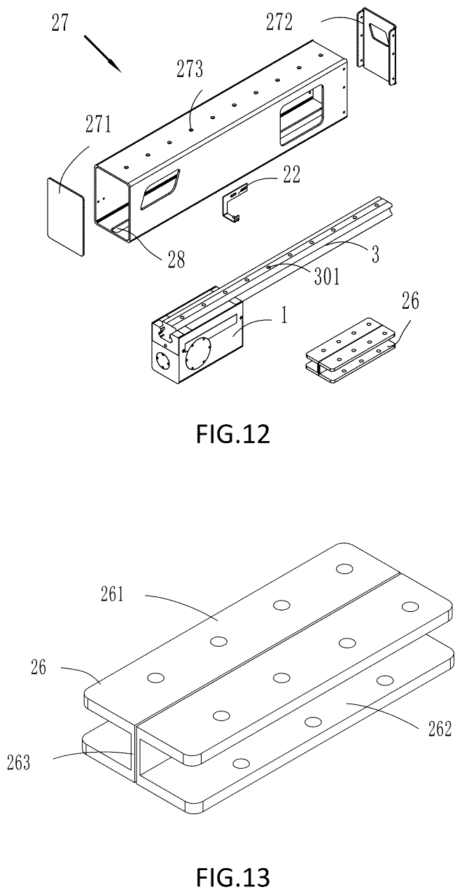

As shown in FIG. 12 for a self-powered integrated vehicle box slide-out system, includes the self-powered integrated motion module of skew axis motion module 23, or intersecting axis motion module 24, or parallel axis motion module 25, a support frame 26 and a load-bearing box 27. One end of the load-bearing box 27 is set with a first sealing plate 271, the other is set with a second sealing plate 272, the top is set with fixing holes 273, one side is equipped with a control component 22, and the bottom is set with a long opening 28.

### As shown in FIG. 13: Support Frame 26 Includes Top Plate 261, Bottom plate 262 and vertical plate 263.

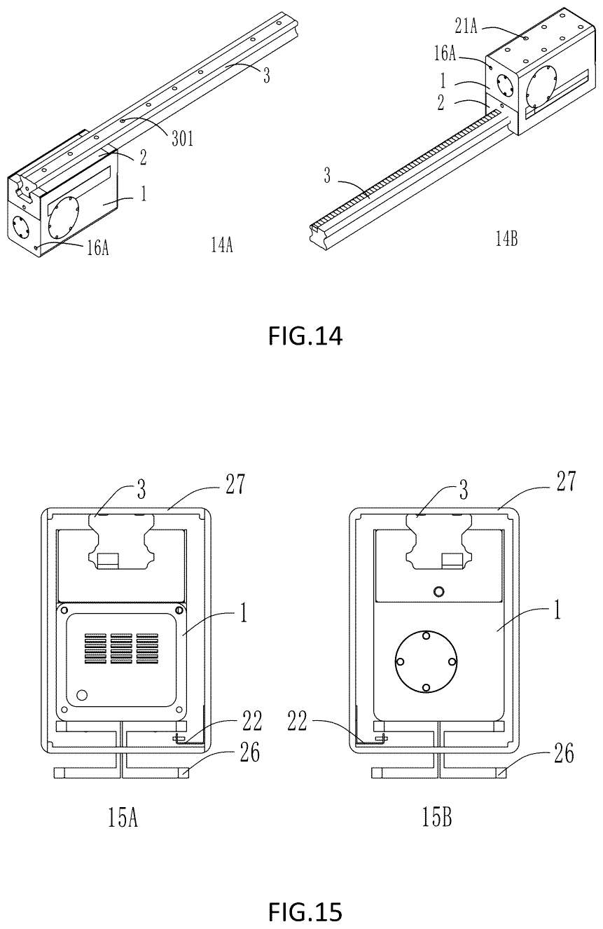

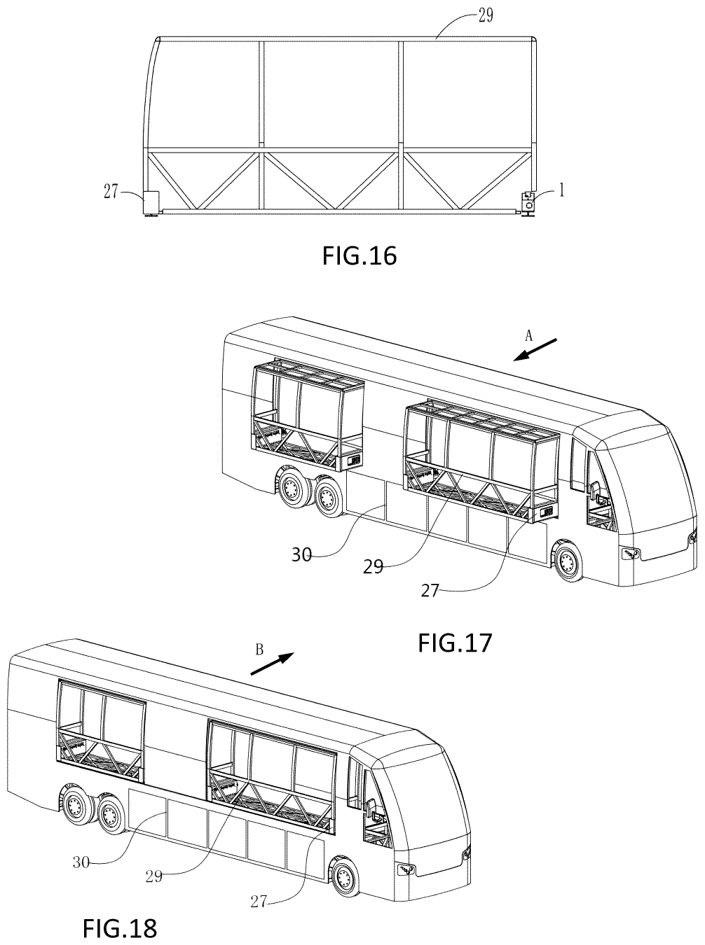

As shown in FIGS. 14, 15, 16: The self-powered integrated motion module is set inside the load-bearing box 27 on either side of the vehicle's slide-out box 29, with connecting holes on linear rack guide rail 3, linear rack guide rail 3 with load-bearing box 27 fixed connection via connection holes 301 and fixing holes 273. Module box 1 (No Protective Roof 101) of the self-powered integrated motion module fixed on the top plate 261 of the support frame 26 through the module box bottom plate connecting holes 21A. The bottom plate 263 is mounted on vehicle body 30, the load-bearing box 27 is set parallel to the corresponding sides at the lower part of the slide-out box 29, and the two bearing boxes 27 have the same internal structure and synchronous linear motion. Control assembly 22 control slide-out box 29 to retract.

As shown in FIGS. 17, 18: When the vehicle is stationary, slide-out box 29 completely slipping out from the opening on vehicle body 30, increase use space inside vehicle body 30. When slide-out box 29 is full retracted, the slide-out box 29 is flush with the vehicle body 30, does not affect the overall aesthetic.

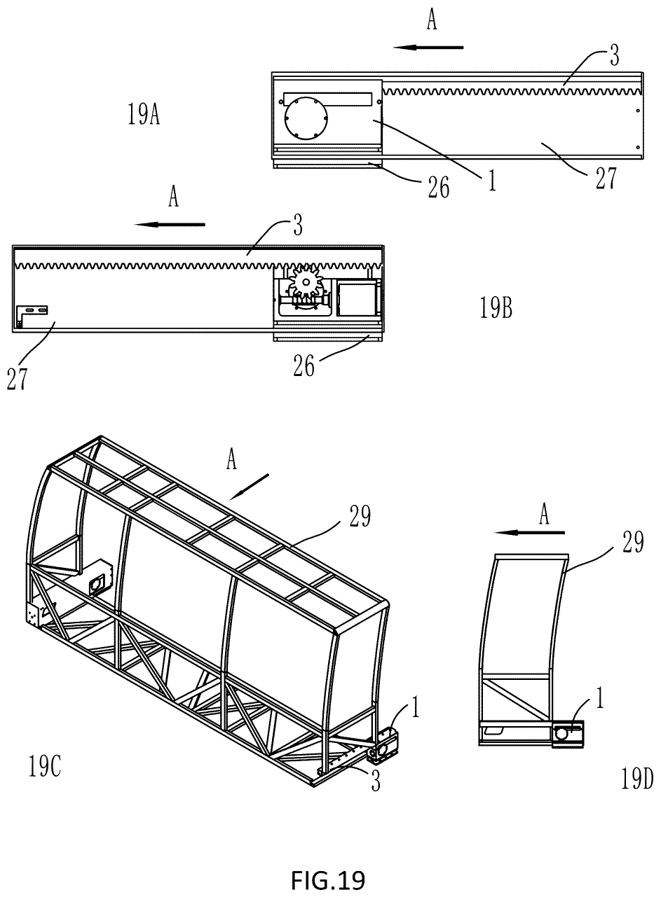

Referring to FIG. 19: a self-powered integrated vehicle box sliding out system, the sliding out box 29 is fixed in the opening of the vehicle body through the support frame 26, the motor 5 is energized and positively rotating, driving the skew axis motion module 23, or the intersecting axis motion module 24, or the parallel axis motion module 25 to drive the linear rack guide rail 3 to move, and the linear rack guide rail 3 drives the load-bearing box 27 to slide outward, and the load-bearing box 27 is then carried out to do slide out action on both sides of the vertical plate 263 through the long strip opening 28. The specific length position of the sliding out box sliding out is set in advance, the sliding out movement stops, and the sliding out box 29 slides out completely from the opening of the vehicle body, as shown in the direction of arrow A.

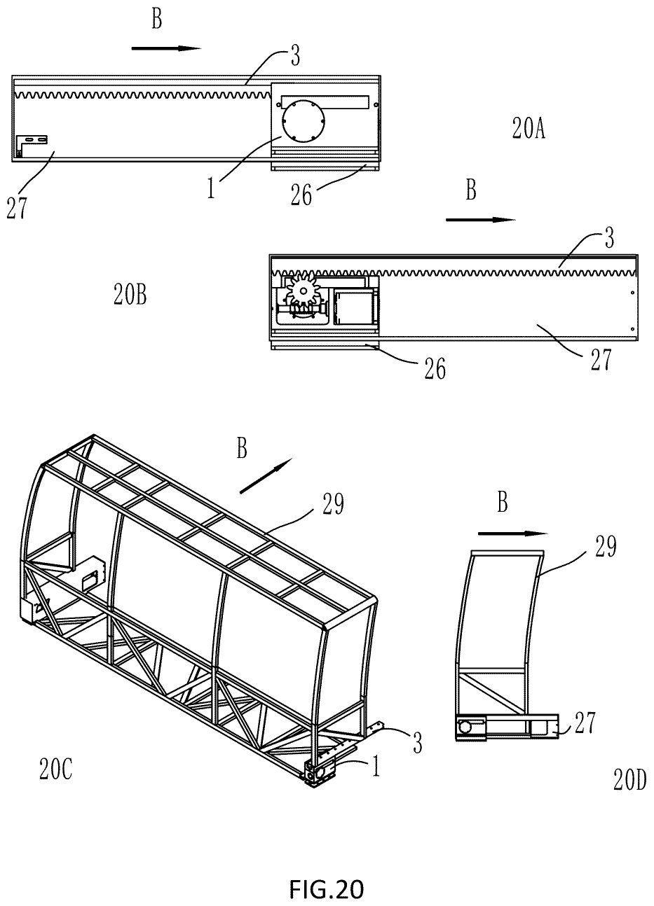

Referring to FIG. 20: a self-powered integrated vehicle box sliding out system, the sliding out box 29 is fixed in the opening of the vehicle body through the support frame 26, the motor 5 is energized and reversely rotating, driving the skew axis motion module 23, or the intersecting axis motion module 24, or the parallel axis motion module 25 to drive the linear rack guide rail 3 to move, and the linear rack guide rail 3 drives the load-bearing box 27 to retract, and slide on both sides of the vertical plate 263 through the long strip opening 28. The slide-out box retraction is controlled by the control assembly 22 to a position specifically where the retraction movement stops and the slide-out box 29 is fully retracted from the vehicle opening, as shown in the direction of arrow B.

The foregoing description of the disclosed embodiments enables those skilled in the art to realize or use the present invention. Various modifications to these embodiments will be apparent to those skilled in the art, and the general principles defined herein may be realized in other embodiments without departing from the spirit or scope of the present invention. Accordingly, the present invention will not be limited to these embodiments shown herein but will be subject to the broadest scope consistent with the principles and novel features disclosed herein.

1. A self-powered integrated skew axis motion module, comprising a module box, a skew gear assembly, a skew axis power box, a skew axis gearbox, a motor, a slider, and a linear rack guide rail, wherein the module box contains the skew axis power box and the skew axis gearbox, the motor is set in the skew axis power box, and a skew gear assembly is set in the skew axis gearbox. The slider is disposed at the top of the module box, the linear rack guide rail is disposed inside the slider, thereby achieving self-powered integrated linear synchronous motion, wherein the linear rack guide rail performs reciprocating, unlimited circular linear motion on the slider, enabling a load-bearing body to perform high-load and high-precision linear motion along the linear rack guide rail.

2. The self-powered integrated skew axis motion module according to claim 1, wherein the skew axis power box and the gearbox are separated by a first partition, the first partition is provided with a first power hole, and the driving power box contains a motor.

3. The self-powered integrated skew axis motion module according to claim 1, wherein the lower part of the slider and the top of the gearbox are provided with a slider bottom opening, communicating with the gearbox, and one end of the outside of the gearbox is provided with a skew axis gearbox oil nozzle.

4. The self-powered integrated skew axis motion module according to claim 3, wherein the module box bottom plate is provided with multiple module box bottom plate connecting holes and the top guard is provided with multiple module box top plate fixing holes, one side of the module box near the skew axis power box is provided with a first motor heat radiation lid, and the first motor heat radiation lid has a first cable routing hole.

5. The self-powered integrated skew axis motion module according to claim 1, wherein the skew axis gearbox 18A is integrally provided with an output shaft, a worm, a worm gear, a skew axis output gear, a first snap spring, a second snap spring, a first bearing, a second bearing, a third bearing, and a fourth bearing. The output gear is meshed with the linear rack guide rail through the slider bottom opening.

6. The self-powered integrated skew axis motion module according to claim 4, outside the module box, a first seal ring, a second seal ring, a third seal ring, a first bearing cap, a second bearing cap and a third bearing cap are set. The first seal ring, the first bearing cap and the first bearing are set together. The second seal ring, the second bearing cap and the second bearing are set together. The third seal ring, the third bearing cap and the third bearing are set together. The fourth seal ring is set on the first power hole and is set with the fourth bearing.

7. A self-powered integrated intersecting axis motion module includes a module box, an intersecting gear assembly, an intersecting axis power box, an intersecting axis gearbox, a motor, a slider, and a linear rack guide rail, a second partition, a second motor heat radiation lid, a second cable routing hole, a second power hole, an input bevel gear, a first intersecting output shaft, a second intersecting output shaft, an output bevel gear, a second intersecting axis gear, a third intersecting axis gear, a fourth intersecting axis gear, an intersecting axis gearbox cover, an intersecting axis gearbox oil nozzle, a first intersecting axis bearing, a second intersecting axis bearing, a third intersecting axis bearing, a fourth intersecting axis bearing, a fifth intersecting axis bearing, and a sixth intersecting axis bearing, a first intersecting axis seal ring, a second intersecting axis seal ring, a first intersecting axis snap spring, a second intersecting axis snap spring, and a third intersecting axis snap spring. The slider is set at the top of the module box, and the linear rack guide rail is set inside the slider. The intersecting axis gear is meshed with the linear rack guide rail through the slider bottom opening. The module box is equipped with the intersecting axis power box and the intersecting axis gearbox, the second partition is set in L-shape, the second partition is provided with a second power hole, the intersecting axis power box and the intersecting axis gear box are separated by the second partition. The intersecting axis power box is provided with the motor. The intersecting axis power box is provided with the motor, the second motor heat radiation lid is provided with a second cable routing hole, the second motor heat radiation lid is provided in correspondence with the second intersecting axis seal ring, the output shaft of the motor is provided with a first intersecting axis bearing and a second intersecting axis bearing, and the motor is connected to the input bevel gear through the second power hole. The intersecting axis gear box is provided intersecting gear assembly. Intersecting axis gear box cover is provided in correspondence with first intersecting axis seal ring, the first intersecting output shaft is provided with third intersecting axis gear, fourth intersecting axis gear, first intersecting axis bearing, second intersecting axis bearing, second intersecting axis snap spring. Second intersecting output shaft is provided with output bevel gear, second intersecting axis gear, third intersecting axis bearing, fourth intersecting axis bearing, first intersecting axis snap spring, and third intersecting axis snap spring. The input bevel gear 240 engages with the output bevel gear, and the output bevel gear drives the second intersecting axis gear. Through the first intersecting output shaft and the third intersecting axis gear the fourth intersecting axis gear is driven to rotate. the fourth intersecting axis gear meshes with the linear rack guide rail 3 through the slider bottom opening, and the intersecting axis gearbox is provided with an intersecting axis gearbox oil nozzle on the outer side of the intersecting axis gearbox for providing lubrication to the intersecting gear assembly inside the intersecting axis gearbox.

8. A self-powered integrated parallel axis motion module includes a module box, a parallel gear assembly, a parallel axis power box, a parallel axis gearbox, a motor, a slider, and a linear rack guide rail, a third partition, a third motor heat radiation lid, a third cable routing hole, a third power hole, a parallel axis motor gear, a first parallel output shaft, a second parallel output shaft, a first parallel axis gear, a second parallel axis gear, a third parallel axis gear, a fourth parallel axis gear, a parallel axis gearbox cover, a parallel axis gearbox oil nozzle, a first parallel axis bearing, a second parallel axis bearing, a third parallel axis bearing, a fourth parallel axis bearing, a first parallel axis seal ring, a second parallel axis seal ring, a first parallel axis snap spring, a second parallel axis snap spring, a third parallel axis snap spring, and a fourth parallel axis snap spring. The slider is set at the top of the module box, and the linear rack guide rail is set inside the slider. The module box is equipped with the parallel axis power box and the parallel axis gearbox, the third partition is L-shaped, the parallel axis power box and the parallel axis gear box are separated by the third partition. The parallel power box is provided with a motor inside, the third motor heat radiation lid is provided with a third cable routing hole, the third motor heat radiation lid and the second parallel axis seal ring are provided correspondingly. Inside the gear box 18C, the output shaft of the motor is provided with a parallel axis motor gear and a first parallel axis snap spring. The parallel axis gear box is provided with a parallel gear assembly, and a parallel axis gearbox cover and first parallel axis seal ring are provided correspondingly. The parallel motor gear engaging the first parallel axis gear. The first parallel output shaft is fixed with the first parallel axis gear and the second parallel axis gear. And the second parallel output shaft is fixed with the third parallel axis gear and the fourth parallel axis gear at the same time. The second parallel axis gear meshing with the third parallel axis gear, the fourth parallel axis gear meshing with the linear rack guide rail through the slider bottom opening. The first parallel axis gear, second parallel axis gear, third parallel axis gear and fourth parallel axis gear are provided parallel to the lengthwise direction of the linear rack guide rail. The parallel axis gear box is provided with a parallel axis gearbox oil nozzle at the outer side.

9. According to any one of claims 1, claim 7, claim 8, the self-powered integrated skew axis motion module, intersecting axis motion module and parallel axis motion module, wherein the slider and the linear rack guide rail can be of various types including sliding friction, rolling friction, and fluid friction.

10. According to any one of claims 1, claim 7, claim 8, the self-powered integrated skew axis motion module, intersecting axis motion module and parallel axis motion module, wherein the linear rack guide rail can be a combination of a rack and a guide rail, or the rack can be directly processed on the guide rail.

11. According to any one of claims 1, claim 7, claim 8, the self-powered integrated skew axis motion module, intersecting axis motion module and parallel axis motion module, wherein the top of the module box is set with a top guard above the gear rail. According to the different application scenario, if the carried object needs to be connected and fixed with the first connection fixing holes on the linear rack guide rail, the top guard can be selected to be disassembled without being used, and if the carried object needs to be connected and fixed with the second end connection fixing hole and the third end connection fixing hole of the linear rack guide rail, the top guard need not be disassembled.

12. A self-powered integrated vehicle box slide-out system, comprising a self-powered integrated skew axis motion module, or the intersecting axis motion module or the parallel axis motion module, a support frame, a load-bearing box, and a slide-out box, wherein the self-powered integrated motion module of the skew axis motion module, or the intersecting axis motion module or the parallel axis motion module is disposed inside the load-bearing box, the bottom of the module box is provided with an module box bottom plate connection hole fixedly connected with the top plate of the support frame, the linear rack guide rail is fixedly connected with the top of the load-bearing box, the self-powered integrated motion module of the skew axis motion module, or the intersecting axis motion module or the parallel axis motion module, and the load-bearing box are arranged in parallel on both corresponding sides below the slide-out box, and move synchronously, wherein the load-bearing box is not visible from the outside, and when the vehicle is stationary, the slide-out box fully extends from the opening of the vehicle body, increasing the interior space of the vehicle, and when retracted, the slide-out box is flush with the exterior of the vehicle body, not affecting the overall aesthetic appearance.

13. The self-powered integrated vehicle box slide-out system according to claim 12, wherein the bottom of the load-bearing box is provided with a long strip opening, and one side is provided with a control assembly for controlling the retraction length and position of the slide-out box.

14. The self-powered integrated vehicle box slide-out system according to claim 12 wherein the support frame comprises a top plate, a bottom plate, and a vertical plate.

15. The self-powered integrated vehicle box slide-out system according to claim 12, wherein the slide-out box is arranged in parallel with the self-powered integrated motion module of the skew axis motion module, or the intersecting axis motion module or the parallel axis motion module.
